(19) United States
(12) Patent Application Publication
(10) Pub. No.: US 2010/0034436 A1
(43) Pub. Date: Feb. 11, 2010

(54) IMAGE PROCESSING APPARATUS, COMPUTER PROGRAM PRODUCT AND IMAGE PROCESSING METHOD

(75) Inventor: Takashi Kono, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/431,237

(22) Filed: Apr. 28, 2009

(30) Foreign Application Priority Data
Apr. 28, 2008 (JP) 2008-117687

(51) Int. Cl. G06K 9/00

(52) U.S. Cl. 382/128

(57) ABSTRACT

An image processing apparatus includes a motion-vector calculating unit that calculates motion vectors among images taken by an imaging device; a candidate-center calculating unit that calculates candidate centers of a movement of the imaging device and/or candidate centers of a movement of an imaging subject seen on each of the images based on the motion vectors calculated by the motion-vector calculating unit; a reliability calculating unit that calculates a reliability of each of the candidate centers based on a distance between the candidate centers calculated by the candidate-center calculating unit; and a motion-information obtaining unit that obtains information for detecting a motion change among the images taken by the imaging device based on the reliability calculated by the reliability calculating unit.

### CROSS-REFERENCE TO RELATED APPLICATIONS

This application is based upon and claims the benefit of priority from Japanese Patent Application No. 2008-117687, filed on Apr. 28, 2008, the entire contents of which are incorporated herein by reference.

### BACKGROUND OF THE INVENTION

1. Field of the Invention

The present invention relates to an image processing apparatus, a computer program product, and an image processing method.

2. Description of the Related Art

Recently, in the field of endoscope, there has been developed a swallowable-type capsule endoscope (an imaging device), in which an imaging function of taking an in-vivo image of a subject, a transmitting function of wirelessly-transmitting image data captured by an imaging unit, and the like are contained in a capsule-shaped casing. The capsule endoscope is swallowed by a patient as a subject through his/her mouth for an examination, and introduced into the body. The capsule endoscope moves through the body, for example, inside organs, such as esophagus, stomach, small intestine, and large intestine, according to the peristaltic action until the capsule endoscope is naturally excreted from the body. While moving through the body, the capsule endoscope sequentially takes images of an intralumen as an object to be taken, for example, at 2 to 4 frames per second (frames/sec), and wirelessly transmits captured image data to a receiving device outside the body. The in-vivo images of the subject, which are taken by the capsule endoscope and received by the receiving device outside the body, are sequentially displayed on a diagnostic workstation or the like in chronological order to be checked by an observer such as a doctor.

The capsule endoscope takes a large number of images. Therefore, in the diagnostic workstation or the like, for example, a process of detecting motion changes among serially-taken images is performed based on similarities of the images. A display time of each of the images is adjusted, for example, in such a manner that an image that undergoes a great change is displayed for a long time, and an image that undergoes a small change is displayed for a short time, thereby improving the efficiency in checking of the images.

The motion changes among the images are detected, for example, in such a manner that motion vectors among serially-taken images are calculated, motion changes among the images are classified into motion patterns, such as a parallel movement, a forward movement, a backward movement, and a rotational movement based on directions of the motion vectors or the like. Therefore, by classifying the motion patterns into finer motion patterns with accuracy, an accuracy of detecting the motion changes among the images can be improved. To classify the motion patterns finely, the center of movement, such as a forward movement, a backward movement, or a rotational movement seen on each of the images needs to be calculated accurately. For example, in a technique disclosed in Japanese Patent Application Laid-open No. S61-269475, a correlation value obtained among images is assigned to a candidate vector with respect to each split screen, and an amount of a parallel movement of the whole screen is obtained based on a candidate vector having a high correlation value. Furthermore, Japanese Patent Application Laid-open No. H8-22540 discloses a technique for recognizing a circle or an arc based on a contour vector of a graphic and calculating the center of the recognized circle or arc.

### SUMMARY OF THE INVENTION

An image processing apparatus according to an aspect of the present invention includes: a motion-vector calculating unit that calculates motion vectors of serial images of a subject, the images being taken by an imaging device moving with respect to the subject and/or images being images of the subject moving with respect to the imaging device and taken by the imaging device; a candidate-center calculating unit that calculates candidate centers of a movement of the imaging device and/or candidate centers of a movement of the subject seen on the images based on the motion vectors calculated by the motion-vector calculating unit; a reliability calculating unit that calculates a reliability of each of the candidate centers based on a distance between the candidate centers calculated by the candidate-center calculating unit; and a motion-information obtaining unit that obtains information for detecting a motion change among the images taken by the imaging device based on the reliability calculated by the reliability calculating unit.

A computer program product according to another aspect of the present invention has a computer readable medium including programmed instructions for processing serially-taken images of a subject taken by an imaging device moving with respect to the subject and/or serially-taken images of the subject moving with respect to the imaging device and taken by the imaging device, wherein the instructions, when executed by a computer, cause the computer to perform: calculating motion vectors of the images taken by the imaging device; calculating candidate centers of a movement of the imaging device and/or candidate centers of a movement of the subject seen on the images based on the calculated motion vectors; calculating a reliability of each of the candidate centers based on a distance between the calculated candidate centers; and obtaining information for detecting a motion change among the images taken by the imaging device based on the calculated reliability.

An image processing method according to still another aspect of the present invention, for processing serially-taken images of a subject taken by an imaging device moving with respect to the subject and/or serially-taken images of the subject moving with respect to the imaging device and taken by the imaging device, includes: calculating motion vectors of the images taken by the imaging device; calculating candidate centers of a movement of the imaging device and/or candidate centers of a movement of the subject seen on the images based on the calculated motion vectors; calculating a reliability of each of the candidate centers based on a distance between the calculated candidate centers; and obtaining information for detecting a motion change among the images taken by the imaging device based on the calculated reliability.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram showing an entire configuration of an image processing system including an image processing apparatus according to a first embodiment;

FIG. 2 is a block diagram illustrating a functional configuration of the image processing apparatus according to the first embodiment;

FIG. 3 is a flowchart of a procedure of a process performed by the image processing apparatus according to the first embodiment;

FIG. 4 is a diagram illustrating a candidate-forward/backward-center calculating process;

FIG. 5 is another diagram illustrating the candidate-forward/backward-center calculating process;

FIG. 6 is still another diagram illustrating the candidate-forward/backward-center calculating process;

FIG. 7 is a flowchart of a detailed processing procedure of the candidate-forward/backward-center calculating process;

FIG. 8 is a diagram illustrating the principle of calculating a reliability of a candidate forward/backward center;

FIG. 9 is a flowchart of a detailed processing procedure of a candidate-forward/backward-center reliability calculating process;

FIG. 10 is a graph illustrating a correspondence relation between reliability and distance;

FIG. 11 is a block diagram illustrating a functional configuration of an image processing apparatus according to a second embodiment;

FIG. 12 is a flowchart of a procedure of a process performed by the image processing apparatus according to the second embodiment;

FIG. 13 is a diagram illustrating a candidate-rotation-center calculating process;

FIG. 14 is another diagram illustrating the candidate-rotation-center calculating process;

FIG. 15 is still another diagram illustrating the candidate-rotation-center calculating process;

FIG. 16 is a flowchart of a detailed processing procedure of the candidate-rotation-center calculating process;

FIG. 17 is a diagram illustrating the principle of calculating a reliability of a candidate rotation center;

FIG. 18 is a flowchart of a detailed processing procedure of a candidate-rotation-center reliability calculating process;

FIG. 19 is a block diagram illustrating a functional configuration of an image processing apparatus according to a third embodiment;

FIG. 20 is a flowchart of a procedure of a process performed by the image processing apparatus according to the third embodiment; and

FIG. 21 is a flowchart of a detailed processing procedure of a center-coordinates calculating process.

### DETAILED DESCRIPTION

Exemplary embodiments of the present invention will be described in detail below with reference to the accompanying drawings. Incidentally, in the embodiments explained below, there is described an image processing apparatus that processes images serially-taken by a capsule endoscope, which is an example of an imaging device and serially-takes images while moving an intralumen. Furthermore, identical portions in the drawings are denoted with the same reference numerals.

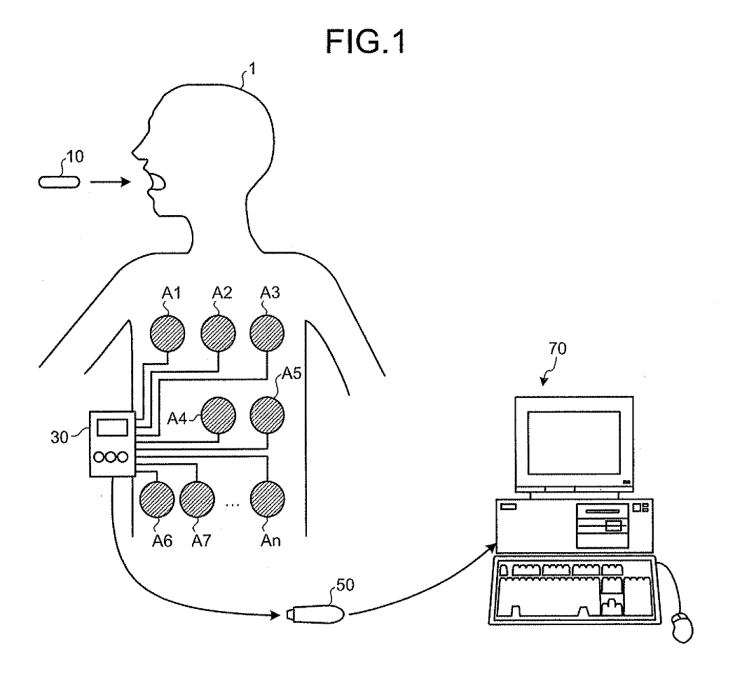

FIG. 1 is a schematic diagram showing an entire configuration of an image processing system including an image processing apparatus 70 according to a first embodiment. As shown in FIG. 1, the image processing system includes a capsule endoscope 10 that takes an image of an intralumen of a subject 1; a receiving device 30 that receives image data wirelessly-transmitted from the capsule endoscope 10; the image processing apparatus 70 that processes the image received by the receiving device 30; and the like. For delivery and receipt of image data between the receiving device 30 and the image processing apparatus 70, for example, a field-portable recording medium (a portable recording medium) 50 is used.

The capsule endoscope 10 includes an imaging function, a wireless function, an illuminating function of illuminating a site to be imaged, and the like. For example, the capsule endoscope 10 is swallowed by the subject 1 such as a human being or an animal through the mouth for an examination, and introduced into the subject 1. Until the capsule endoscope 10 is naturally excreted from the body, the capsule endoscope 10 serially takes and acquires in-vivo images, such as esophagus, stomach, small intestine, and large intestine, at a predetermined imaging rate, and wirelessly transmits the acquired image data to the outside of the body. In the images taken by the capsule endoscope 10, a mucous membrane, contents suspended in a body cavity, bubbles, and the like are seen. Also, an important portion such as a lesion is seen on the image in some cases. The number of images taken by the capsule endoscope 10 roughly corresponds to a value obtained by the imaging rate (about 2 to 4 frames/sec) times an in-vivo staying time of the capsule endoscope (about 8 hours=8×60×60 sec), and is more than several tens of thousands. Furthermore, a speed at which the capsule endoscope 10 passes through the body is not constant, so that images are variously taken by the capsule endoscope 10 such that images that change greatly are serially taken and similar images are serially taken. Incidentally, an intraluminal image taken by the capsule endoscope 10 is a color image having pixel levels (pixel values) with respect to red (R), green (G), and blue (B) color components respectively at each pixel position.

The receiving device 30 includes receiving antennas A1 to An that are arranged to be dispersed at positions on the body surface corresponding to a passageway of the capsule endoscope 10 inside the subject 1. The receiving device 30 receives image data wirelessly-transmitted from the capsule endoscope 10 via each of the receiving antennas A1 to An. The receiving device 30 is configured to removably attach the portable recording medium 50 thereto, and sequentially stores received image data in the portable recording medium 50. In this manner, the receiving device 30 accumulates in-vivo images of the subject 1 taken by the capsule endoscope 10 in the portable recording medium 50 in chronological order.

The image processing apparatus 70 is embodied by a general-purpose computer such as a workstation or a personal computer, and is configured to removably attach the portable recording medium 50 thereto. The image processing apparatus 70 acquires an image stored in the portable recording medium 50 and processes the acquired image, and then displays the processed image on a display such as a liquid crystal display (LCD) or an electro luminescent display (ELD).

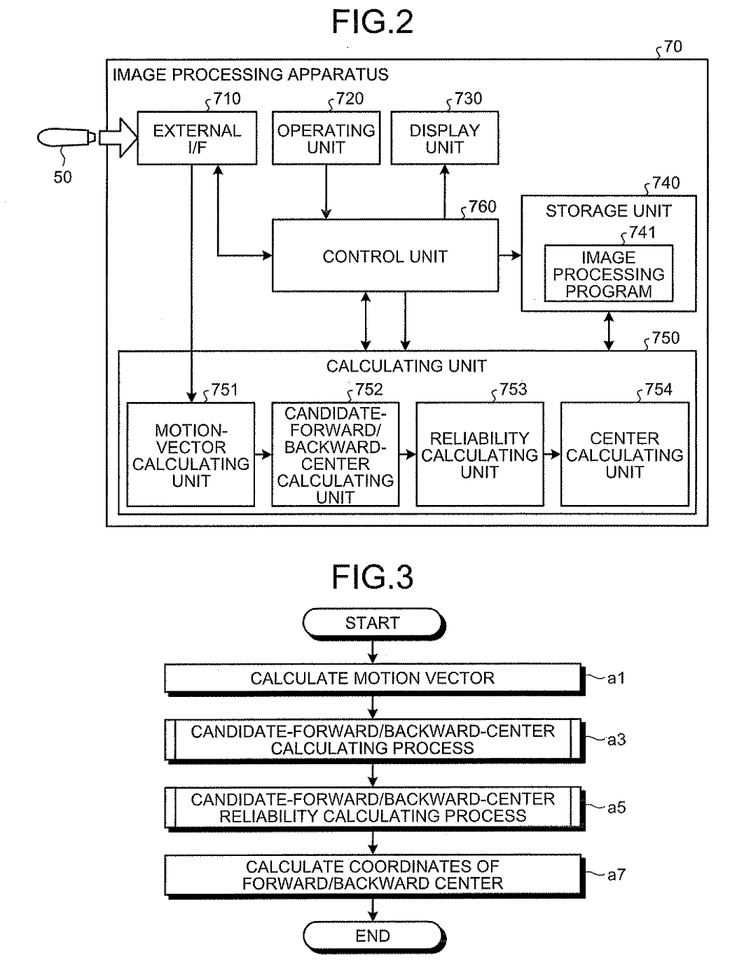

FIG. 2 is a block diagram illustrating a functional configuration of the image processing apparatus 70. In the first embodiment, the image processing apparatus 70 includes an external interface (I/F) 710, an operating unit 720, a display unit 730, a storage unit 740, a calculating unit 750, and a control unit 760 that controls the operation of the entire image processing apparatus 70.

The external I/F 710 is used to acquire image data that is taken by the capsule endoscope 10 and received by the receiving device 30. The external I/F 710 removably mounts, for example, the portable recording medium 50 thereon, and is embodied by a reader device that reads out image data stored in the portable recording medium 50. The image data read out from the portable recording medium 50 via the external I/F 710 is stored in the storage unit 740 and processed by the calculating unit 750, and then displayed on the display unit 730 under the control of the control unit 760. Incidentally, the acquisition of an image taken by the capsule endoscope 10 is not limited to the configuration using the portable recording medium 50. For example, instead of the portable recording medium 50, a server can be separately provided, and an image taken by the capsule endoscope 10 can be stored in the server in advance. In this case, the external I/F is embodied by, for example, a communication device for connection to the server so that data communication with the server can be performed via the external I/F, and an image can be acquired from the server. Or, an image taken by the capsule endoscope 10 can be stored in the storage unit 740 in advance so that the image can be read out and acquired from the storage unit 740.

The operating unit 720 is embodied by, for example, a keyboard, a mouse, a touch panel, switches, and the like, and outputs an operation signal to the control unit 760. The display unit 730 is embodied by a display device, such as an LCD or an ELD, and displays thereon various screens including a display screen on which an image taken by the capsule endoscope 10 is displayed under the control of the control unit 760.

The storage unit 740 is embodied by a variety of integrated circuit (IC) memories, for example, a read-only memory (ROM) and a random access memory (RAM), such as a flash memory in which data can be updatably stored, an information storage medium, such as a built-in hard disk, a hard disk connected via a data communication terminal, and compact disk read-only memory (CD-ROM), a reader device, and the like. The storage unit 740 stores therein a program for operating the image processing apparatus 70 thereby realizing various functions included in the image processing apparatus 70, data used during execution of the program, and the like. Furthermore, the storage unit 740 stores therein an image processing program 741. The image processing program 741 is a program for obtaining a forward/backward center on an image that is taken by the capsule endoscope 10 and determined that a pattern of changes in motion (a motion pattern) of the image with respect to another image taken at a different time is either “a forward movement” or “a backward movement”. The “forward/backward center” is the center of the forward movement or the backward movement (the forward/backward movement) of the capsule endoscope 10 with respect to an imaging subject seen on an image and/or the center of the forward/backward movement of the imaging subject with respect to the capsule endoscope 10.

The calculating unit 750 processes an image taken by the capsule endoscope 10 and performs various calculating processes for obtaining the forward/backward center in the image. The calculating unit 750 includes a motion-vector calculating unit 751, a candidate-forward/backward-center calculating unit 752, a reliability calculating unit 753, and a center calculating unit 754 as a motion-information obtaining unit. The motion-vector calculating unit 751 compares an image to be processed with another image, and calculates a motion vector. The candidate-forward/backward-center calculating unit 752 calculates a candidate forward/backward center as a candidate center of the forward/backward movement based on the motion vector. The reliability calculating unit 753 calculates a reliability of the candidate forward/backward center. The center calculating unit 754 calculates coordinates of the forward/backward center.

The control unit 760 is embodied by hardware such as a central processing unit (CPU). The control unit 760, for example, issues an instruction or performs data transfer to each of the units composing the image processing apparatus 70 based on image data acquired via the external I/F 710, an operation signal input through the operating unit 720, a program and data stored in the storage unit 740, and the like. The control unit 760 controls the operation of the entire image processing apparatus 70.

Subsequently, a procedure of a process performed by the image processing apparatus 70 according to the first embodiment will be described below with reference to a flowchart shown in FIG. 3. The process explained below is carried out by the operation of each of the units in the image processing apparatus 70 in accordance with the image processing program 741 stored in the storage unit 740. Incidentally, in the first embodiment, the forward/backward center seen on an image taken by the capsule endoscope 10 shall be obtained. In the present process, an image whose motion pattern is determined as either “the forward movement” or “the backward movement” will be an object to be processed. Specifically, an image taken by the capsule endoscope 10 moving forward or backward is an object to be processed. In addition, an image that changes because an imaging subject has moved with respect to the capsule endoscope 10 due to contractions or deformations of a digestive tract mucous membrane caused by peristalsis is also an object to be processed. This image change seems to be caused as if the capsule endoscope 10 has moved forward or backward. Furthermore, an image that changes because an imaging subject has moved due to deformations of an organ such as small intestine is also an object to be processed. This image change seems to be caused as if the capsule endoscope 10 has moved forward or backward. A motion pattern of an image can be determined by using a well-known technique arbitrarily.

As shown in FIG. 3, in the image processing apparatus 70 according to the first embodiment, first, the motion-vector calculating unit 751 calculates a motion vector (Step a1). Specifically, the motion-vector calculating unit 751 compares an image to be processed with, for example, an image immediately before the image to be processed in chronological order (hereinafter, referred to as “a chronologically previous image”). Then, the motion-vector calculating unit 751 makes an association of a position of the same subject seen on each of the images between the image to be processed and the chronologically previous image, and calculates vector data indicating an amount of change of the position as a motion vector.

For example, the motion-vector calculating unit 751 divides the chronologically previous image into blocks, and sets plural search areas in the chronologically previous image. Then, the motion-vector calculating unit 751 sequentially uses the search areas as templates, and performs a well-known template matching to search a position matching best with each of the templates (a position having the highest correlation value) from the image to be processed. As the technique of the template matching, for example, a technique disclosed in “Digital image processing” by Masatoshi Okutomi, et al., the Computer Graphic Arts Society, 22 Jul. 2004, pages 202 to 204, can be used. Incidentally, as a result of the search, when any matching area is not found, or when an obtained correlation value is low, the matching results in failure. As a result of the template matching, a template position most similar to the search area set in the chronologically previous image is searched from the image to be processed, and its correlation value is obtained. Then, a motion vector is calculated based on a template position succeeding in the matching out of searched template positions. For example, a change in central coordinates between the search area and the searched corresponding template position is calculated as a motion vector.

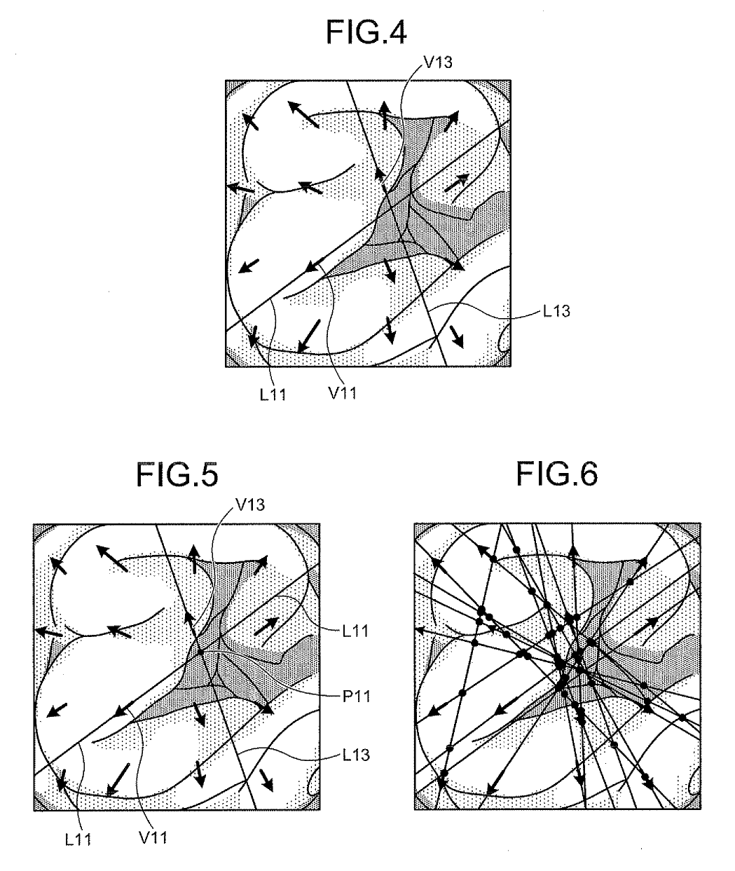

Subsequently, the candidate-forward/backward-center calculating unit 752 executes a candidate-forward/backward-center calculating process (Step a3). FIGS. 4 and 5 are diagrams illustrating the candidate-forward/backward-center calculating process, and each shows an example of the image to be processed. Specifically, FIGS. 4 and 5 show an image whose motion pattern is determined as “the forward movement”, and further show motion vectors calculated on the basis of the chronologically previous image. With a focus on motion vectors V11 and V13, first, as shown in FIG. 4, straight lines L11 and L13 extending along the motion vectors V11 and V13, respectively, are set. Then, as shown in FIG. 5, a position where the set straight lines L11 and L13 intersect (an intersection) is calculated as a candidate forward/backward center P11. FIG. 6 shows a situation in which straight lines along all the motion vectors are set, and intersections of the set straight lines are calculated as candidate forward/backward centers in the same manner as described above with reference to FIGS. 4 and 5. Incidentally, also in a case of an image whose motion pattern is determined as “the backward movement”, candidate forward/backward centers are calculated in the same manner. In the case of “the backward movement”, motion vectors pointing in opposite directions to those in the case of “the forward movement” are obtained.

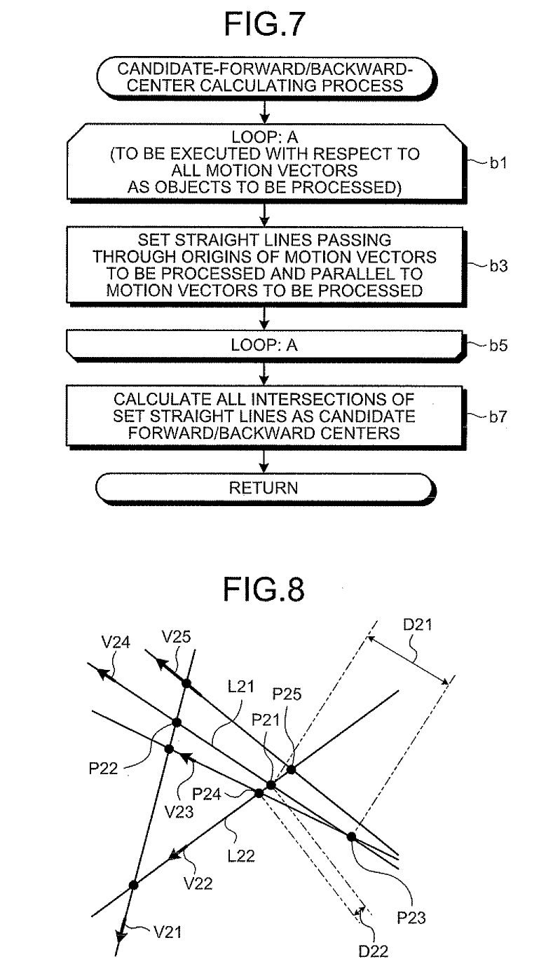

FIG. 7 is a flowchart showing a detailed processing procedure of the candidate-forward/backward-center calculating process. In the candidate-forward/backward-center calculating process, the candidate-forward/backward-center calculating unit 752 first performs a process of a loop A (Steps b1 to b5) with respect to all the motion vectors calculated at Step a1 shown in FIG. 3 as objects to be processed. Namely, the candidate-forward/backward-center calculating unit 752 sets straight lines passing through origins of the motion vectors to be processed and parallel to the motion vectors to be processed, respectively (Step b3). When the process of the loop A is completed, i.e., the straight lines with respect to all the motion vectors have been set, the candidate-forward/backward-center calculating unit 752 next calculates coordinates of each of intersections at which the set straight lines intersect, and sets the intersections as candidate forward/backward centers (Step b7). After that, the control returns to Step a3 shown in FIG. 3, and then proceeds to Step a5.

Namely, at Step a5 shown in FIG. 3, the reliability calculating unit 753 executes a candidate-forward/backward-center reliability calculating process, and calculates a reliability of each of the candidate forward/backward centers. In the candidate-forward/backward-center reliability calculating process, a reliability of each of the candidate forward/backward centers is calculated based on a distance between the candidate forward/backward center and each of the adjacent other candidate forward/backward centers. Specifically, first, out of the other candidate forward/backward centers set on the straight lines passing through the candidate forward/backward center, the closest candidate forward/backward center is selected as an adjacent candidate center. The candidate forward/backward centers are intersections, so that there are two straight lines passing through each of the candidate forward/backward centers. In the present process, an adjacent candidate center set on each of the straight lines is selected. Then, a reliability of each of the candidate forward/backward centers is calculated based on a distance to each of the selected adjacent candidate centers, and a final reliability is calculated based on these values.

FIG. 8 is a diagram illustrating the principle of calculating a reliability of a candidate forward/backward center, and shows five straight lines set with respect to five motion vectors V21 to V25 and eight candidate forward/backward centers as intersections of the straight lines. With a focus on, for example, a candidate forward/backward center P21 shown in FIG. 8, the principle of calculating a reliability of the candidate forward/backward center P21 will be described below. In this case, out of candidate forward/backward centers P22 and P23 that are set on a straight line L21 as one of straight lines passing through the candidate forward/backward center P21 and adjacent to the candidate forward/backward center P21, the closer candidate forward/backward center P23 is selected as an adjacent candidate center. Similarly, out of other candidate forward/backward centers P24 and P25 that are set on a straight line L22 as the other straight line passing through the candidate forward/backward center P21 and adjacent to the candidate forward/backward center P21, the closer candidate forward/backward center P24 is selected as an adjacent candidate center. Then, a reliability of the candidate forward/backward center P21 is calculated based on a distance D21 between the candidate forward/backward center P21 and the adjacent candidate center P23, which is one of the selected adjacent candidate centers. Furthermore, a reliability of the candidate forward/backward center P21 is calculated based on a distance D22 between the candidate forward/backward center P21 and the adjacent candidate center P24, which is the other selected adjacent candidate center. Then, a final reliability of the candidate forward/backward center is calculated, for example, by multiplying the calculated values of the reliability.

The candidate forward/backward centers are concentrated around the forward/backward center. The smaller the distance to each of adjacent other candidate forward/backward centers is, the higher the reliability of the candidate forward/backward center becomes. In the first embodiment, a reliability of the candidate forward/backward center is calculated based on a distance to each of two adjacent candidate centers. Therefore, it is possible to calculate the reliability of the candidate forward/backward center in consideration of a distance to each of plural adjacent candidate forward/backward centers, and thus it is possible to calculate the reliability with high accuracy. Specifically, in this case, a reliability of the candidate forward/backward center can be calculated in consideration of a distance between the candidate forward/backward center and each of closest two candidate forward/backward centers on each straight line passing through the candidate forward/backward center subject to calculation of the reliability. For example, when a reliability of the candidate forward/backward center P21 shown in FIG. 8 is calculated, a value of the reliability can be calculated in consideration of both the distance D21 to the one adjacent candidate center P23 and the distance D22 to the other adjacent candidate center P24.

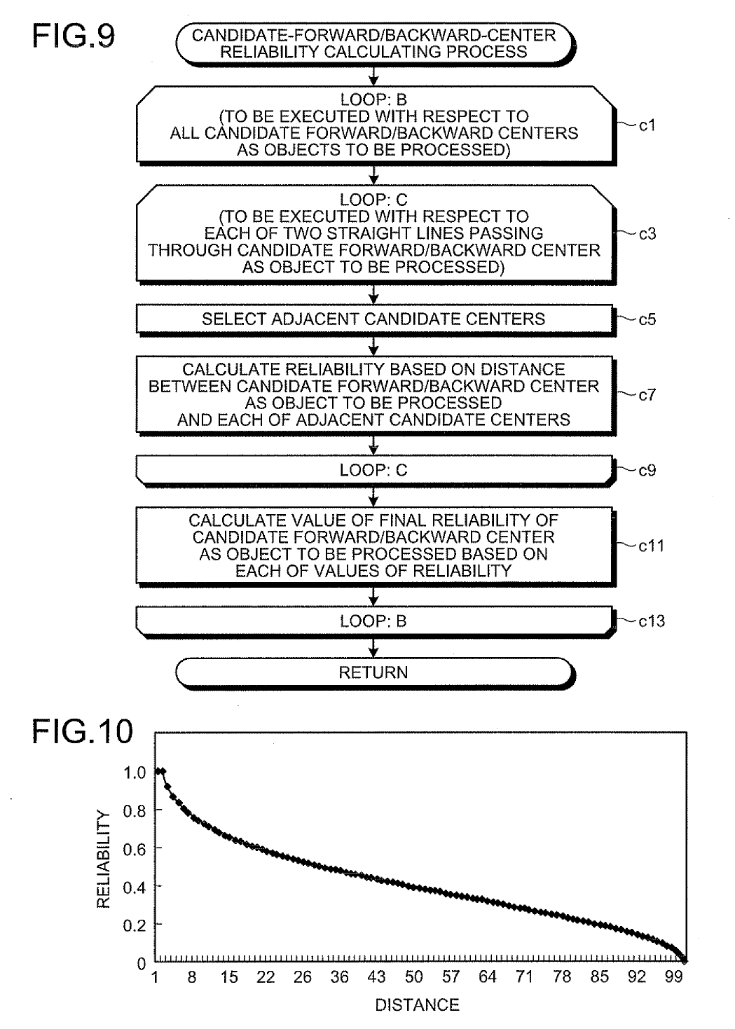

FIG. 9 is a flowchart showing a detailed processing procedure of the candidate-forward/backward-center reliability calculating process. In the candidate-forward/backward-center reliability calculating process, a process of a loop B (Steps c1 to c13) is performed with respect to all the candidate forward/backward centers, which are objects to be processed. In the loop B, a process of a loop C (Steps c3 to c9) is performed with respect to each of the two straight lines passing through the candidate forward/backward center to be processed. Namely, first, the reliability calculating unit 753 selects other candidate forward/backward centers closest to the candidate forward/backward center to be processed on each straight line as adjacent candidate centers (Step c5). Subsequently, the reliability calculating unit 753 calculates a reliability of the candidate forward/backward center to be processed based on a distance between the candidate forward/backward center to be processed and each of the selected adjacent candidate centers (Step c7).

A reliability F is calculated, for example, in accordance with decreasing functions shown in the following equations (1) to (3) depending on a value of x. In this example, the value of x is a value of a distance between a candidate forward/backward center as an object to be processed and a selected adjacent candidate center.

F=(−log₁₀₀x+1)^{1/2}, if 0<x≦100 (1)

F=1, if x=0 (2)

F=0, if x>100 (3)

Furthermore, FIG. 10 is a graph illustrating a correspondence relation between the reliability and distance value indicated by the equations (1) to (3). As shown in FIG. 10, a value of the reliability is set so as to become larger as a distance between the candidate forward/backward center and the selected adjacent candidate center becomes smaller, and set so as to become smaller as a distance between the candidate forward/backward center and the selected adjacent candidate center becomes larger.

When the process of the loop C shown in FIG. 9 is completed, i.e., the adjacent candidate centers have been selected on the straight lines passing through the candidate forward/backward center to be processed, and a reliability of the candidate forward/backward center to be processed has been calculated based on a distance to each of the selected adjacent candidate centers, the control proceeds to Step c11. At Step c11, the reliability calculating unit 753 calculates a value of a final reliability of the candidate forward/backward center to be processed by multiplying the obtained values of the reliability. When the process of the loop B is completed, i.e., the calculation of the reliability of all the candidate forward/backward centers has been performed, the control returns to Step a5 shown in FIG. 3, and then proceeds to Step a7.

Namely, at Step a7 shown in FIG. 3, the center calculating unit 754 calculates coordinates of the forward/backward center based on a coordinate value and a reliability of each of the candidate forward/backward centers calculated in the candidate-forward/backward-center reliability calculating process at Step a5.

Coordinates (x, y) of the forward/backward center are calculated in accordance with a weighted average shown in the following equations (4) and (5) with coordinates (xᵢ, yᵢ) of candidate forward/backward centers and values aᵢ of the reliability of the candidate forward/backward centers.

$$\begin{matrix}x = \frac{{\sum }_{i = 0}^{n} ( {a}_{i} \times {x}_{i} )}{{\sum }_{i = 0}^{n} {a}_{i}} & ( 4 ) \\ y = \frac{{\sum }_{i = 0}^{n} ( {a}_{i} \times {y}_{i} )}{{\sum }_{i = 0}^{n} {a}_{i}} & ( 5 )\end{matrix}$$

As described above, according to the first embodiment, the forward/backward center on an image can be calculated with accuracy regardless of whether the image of the intralumen is taken and obtained by the capsule endoscope 10 moving forward/backward or the image, which changes as if the capsule endoscope 10 has moved forward or backward, of the digestive tract that moves with respect to the capsule endoscope 10 by contractions or the like due to peristalsis is taken. Then, the calculated forward/backward center can be obtained as information for detecting a motion change among images.

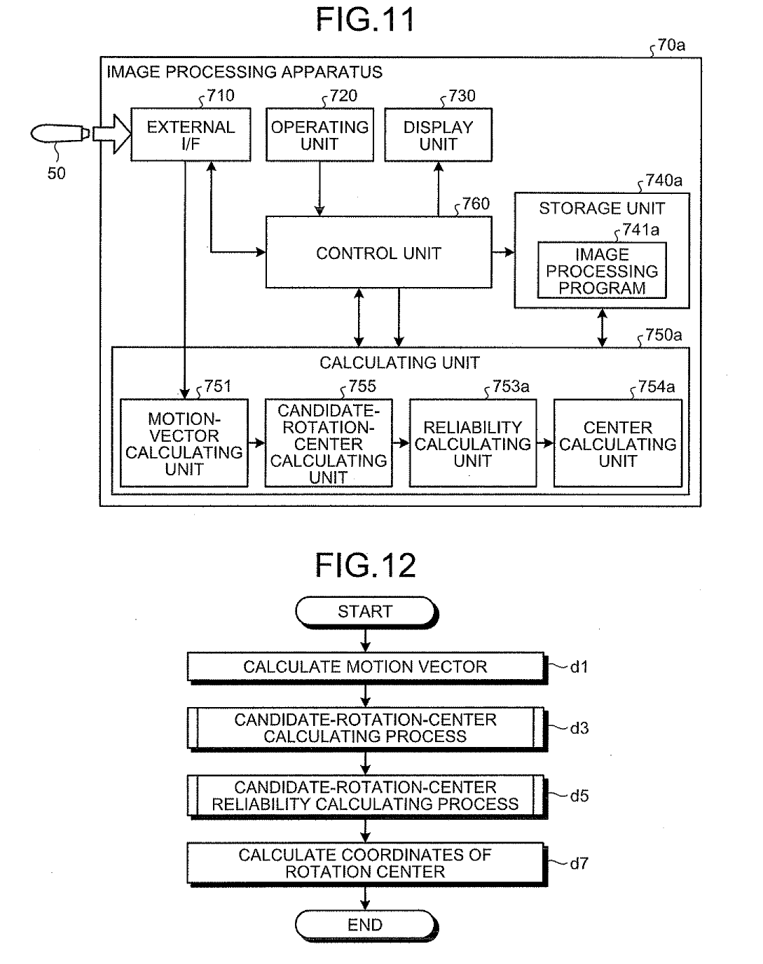

Subsequently, a second embodiment will be described below. FIG. 11 is a block diagram illustrating a functional configuration of an image processing apparatus 70a according to the second embodiment. Incidentally, portions having the same configuration as that in the first embodiment are denoted with the same reference numerals. In the second embodiment, the image processing apparatus 70a includes the external I/F 710, the operating unit 720, the display unit 730, a storage unit 740a, a calculating unit 750a, and the control unit 760 that controls the operation of the entire image processing apparatus 70a. The storage unit 740a stores therein an image processing program 741a for obtaining a rotation center on an image that is taken by the capsule endoscope 10 and determined that a motion pattern of the image with respect to another image taken at a different time is “a rotational movement”. The “rotation center” is the center of the rotational movement of the capsule endoscope 10 with respect to an imaging subject seen on an image and/or the center of the rotational movement of the imaging subject with respect to the capsule endoscope 10.

Furthermore, the calculating unit 750a includes the motion-vector calculating unit 751, a candidate-rotation-center calculating unit 755, a reliability calculating unit 753a, and a center calculating unit 754a as a motion-information obtaining unit. The candidate-rotation-center calculating unit 755 calculates a candidate rotation center as the candidate center of the rotational movement based on a motion vector calculated by the motion-vector calculating unit 751. The reliability calculating unit 753a calculates a reliability of each of the candidate rotation centers. The center calculating unit 754a calculates coordinates of the rotation center.

FIG. 12 is a flowchart of a procedure of a process performed by the image processing apparatus 70a according to the second embodiment. The process explained below is carried out by the operation of each of the units in the image processing apparatus 70a in accordance with the image processing program 741a stored in the storage unit 740a. Incidentally, in the second embodiment, the rotation center seen on an image taken by the capsule endoscope 10 will be obtained. In the present process, an image whose motion pattern is determined as “the rotational movement” is an object to be processed. Specifically, an image taken by the rotating capsule endoscope 10 is an object to be processed. In addition, an image that changes because an imaging subject has moved due to contractions or the like of a digestive tract mucous membrane caused by peristalsis, and an image that changes because an imaging subject has moved due to deformations of an organ, are also objects to be processed. These image changes seem to be caused as if the capsule endoscope 10 has rotated. A motion pattern of an image can be determined by using a well-known technique arbitrarily.

As shown in FIG. 12, in the image processing apparatus 70a according to the second embodiment, first, the motion-vector calculating unit 751 calculates a motion vector (Step d1). This process is performed in the same manner as the process at Step a1 shown in FIG. 3 in the first embodiment.

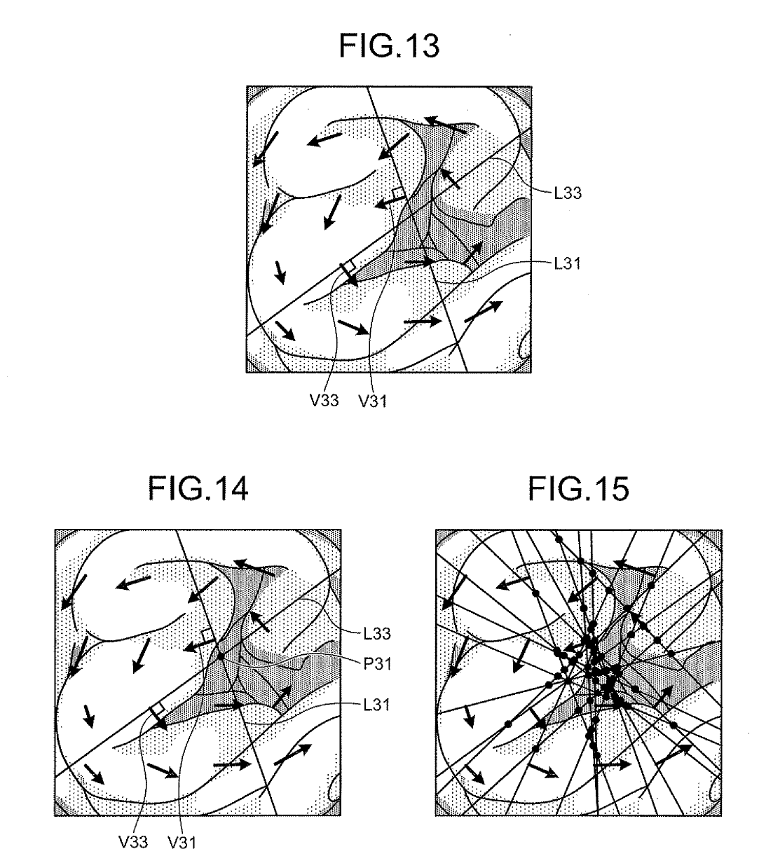

Subsequently, the candidate-rotation-center calculating unit 755 executes a candidate-rotation-center calculating process (Step d3). FIGS. 13 and 14 are diagrams illustrating the candidate-rotation-center calculating process, and each shows an example of the image to be processed. Specifically, FIGS. 13 and 14 show an image whose motion pattern is determined as “the forward movement” and show motion vectors calculated on the basis of a chronologically previous image. With a focus on motion vectors V31 and V33, first, as shown in FIG. 13, straight lines L31 and L33 perpendicular to the motion vectors V31 and V33 and passing through origins of the motion vectors V31 and V33, respectively, are set. Then, as shown in FIG. 14, an intersection of the set straight lines L31 and L33 is calculated as a candidate rotation center P31. FIG. 15 shows a situation in which straight lines along all the motion vectors are set, and intersections of the set straight lines are calculated as candidate rotation centers in the same manner as described above with reference to FIGS. 13 and 14.

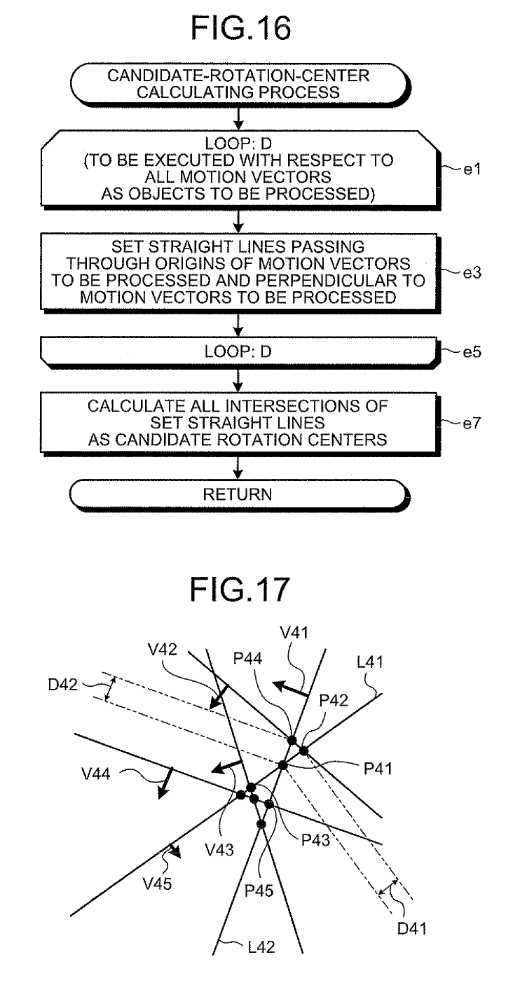

FIG. 16 is a flowchart showing a detailed processing procedure of the candidate-rotation-center calculating process. In the candidate-rotation-center calculating process, the candidate-rotation-center calculating unit 755 first performs a process of a loop D (Steps e1 to e5) with respect to all the motion vectors calculated at Step d1 shown in FIG. 12, which are objects to be processed. Namely, the candidate-rotation-center calculating unit 755 sets straight lines passing through origins of the motion vectors to be processed and perpendicular to the motion vectors to be processed (Step e3). When the process of the loop D is completed, i.e., the straight lines with respect to all the motion vectors have been set, the candidate-rotation-center calculating unit 755 then calculates coordinates of each of intersections at which the set straight lines intersect, and sets the calculated intersections as candidate rotation centers (Step e7). After that, the control returns to Step d3 shown in FIG. 12, and then proceeds to Step d5.

Namely, at Step d5 shown in FIG. 12, the reliability calculating unit 753a executes a candidate-rotation-center reliability calculating process and calculates a reliability of each of the candidate rotation centers. In the candidate-rotation-center reliability calculating process, a reliability of each of the candidate rotation centers is calculated based on a distance between the candidate rotation center and each of the adjacent other candidate rotation centers. Specifically, first, out of the other candidate rotation centers set on the straight lines passing through the candidate rotation center, the closest candidate rotation center is selected as an adjacent candidate center. The candidate rotation centers are intersections, so that there are two straight lines passing through each of the candidate rotation centers. In the present process, an adjacent candidate center set on each of the straight lines is selected. Then, a reliability of each of the candidate rotation centers is calculated based on a distance to each of the selected adjacent candidate centers, and a final reliability is calculated based on these values.

FIG. 17 is a diagram illustrating the principle of calculating a reliability of a candidate rotation center, and shows five straight lines set with respect to five motion vectors V41 to V45 and nine candidate rotation centers, which are intersections of the straight lines. With a focus on, for example, a candidate rotation center P41 shown in FIG. 17, the principle of calculating a reliability of the candidate rotation center P41 will be described below. In this case, out of candidate rotation centers P42 and P43 that are set on a straight line L41, which is one of straight lines passing through the candidate rotation center P41, and adjacent to the candidate rotation center P41, the closer candidate rotation center P42 is selected as an adjacent candidate center. Similarly, out of other candidate rotation centers P44 and P45 that are set on a straight line L42, which is the other straight line passing through the candidate rotation center P41, and adjacent to the candidate rotation center P41, the closer candidate rotation center P44 is selected as an adjacent candidate center. Then, a reliability of the candidate rotation center P41 is calculated based on a distance D41 between the candidate rotation center P41 and the adjacent candidate center P42 that is one of the selected adjacent candidate centers. Furthermore, a reliability of the candidate rotation center P41 is calculated based on a distance D42 between the candidate rotation center P41 and the adjacent candidate center P44 that is the other selected adjacent candidate center. Then, a final reliability of the candidate rotation center is calculated, for example, by multiplying the calculated values of the reliability.

The candidate rotation centers are concentrated around the rotation center. The smaller the distance to each of adjacent other candidate rotation centers is, the higher the reliability of the candidate rotation center becomes. In the second embodiment, a reliability of the candidate rotation center is calculated based on a distance to each of two adjacent candidate centers. Therefore, it is possible to calculate the reliability of the candidate rotation center in consideration of a distance to each of plural adjacent candidate rotation centers, and thus it is possible to calculate the reliability with high accuracy. Specifically, in this case, a reliability of the candidate rotation center can be calculated in consideration of a distance between the candidate rotation center and each of closest two candidate rotation centers on each straight line passing through the candidate rotation center. For example, when a reliability of the candidate rotation center P41 shown in FIG. 17 is calculated, a value of the reliability can be calculated in consideration of both the distance D41 to the one adjacent candidate center P42 and the distance D42 to the other adjacent candidate center P44.

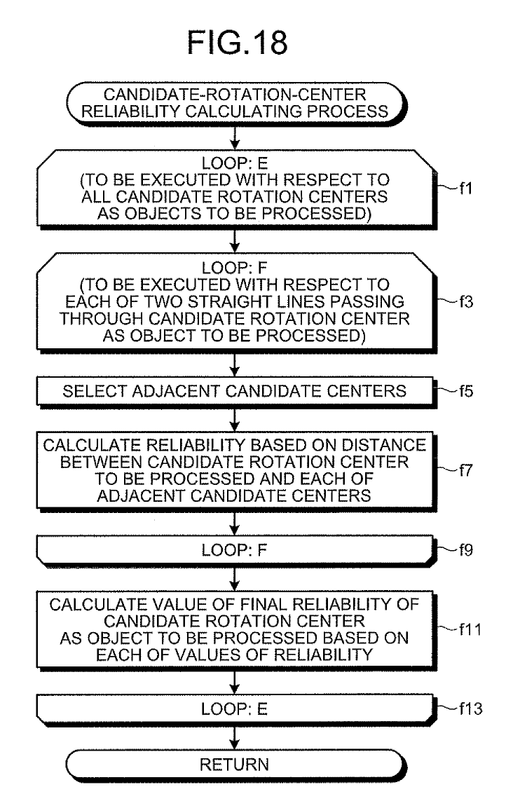

FIG. 18 is a flowchart showing a detailed processing procedure of the candidate-rotation-center reliability calculating process. In the candidate-rotation-center reliability calculating process, a process of a loop E (Steps f1 to f13) is performed with respect to all candidate rotation centers, which are objects to be processed. In the loop E, a process of a loop F (Steps f3 to f9) is performed with respect to each of two straight lines passing through a candidate rotation center as an object to be processed. Namely, first, the reliability calculating unit 753a selects other candidate rotation centers closest to the candidate rotation center to be processed with respect to each straight line from candidate rotation centers set on the straight lines as adjacent candidate centers (Step f5). Subsequently, the reliability calculating unit 753a calculates a reliability of the candidate rotation center to be processed based on a distance between the candidate rotation center to be processed and each of the selected adjacent candidate centers (Step f7). For example, in the same manner as the process at Step c7 shown in FIG. 9 in the first embodiment, the reliability is calculated in accordance with the decreasing functions shown in the equations (1) to (3).

When the process of the loop F is completed, i.e., the adjacent candidate centers have been selected for the straight lines and a reliability based on each selected adjacent candidate center has been calculated, the reliability calculating unit 753a then calculates a value of a final reliability of the candidate rotation center to be processed by multiplying the obtained values of the reliability (Step f11). When the process of the loop E is completed, i.e., the calculation of the reliability of all the candidate rotation centers has been performed, the control returns to Step d5 shown in FIG. 12, and then proceeds to Step d7.

Namely, at Step d7 shown in FIG. 12, the center calculating unit 754a calculates coordinates of the rotation center based on a coordinate value and a reliability of each of the candidate rotation centers calculated in the candidate-rotation-center reliability calculating process at Step d5. For example, in the same manner as the process at Step a7 shown in FIG. 3 in the first embodiment, the coordinates of the rotation center are calculated in accordance with the weighted average shown in the equations (4) and (5).

As described above, according to the second embodiment, the rotation center on an image can be calculated with accuracy regardless of whether the image of the intralumen is taken and obtained by the rotating capsule endoscope 10 or the image, which changes as if the capsule endoscope 10 has rotated, of the digestive tract that moves with respect to the capsule endoscope 10 by contractions or the like due to peristalsis is taken. Then, the calculated forward/backward center can be obtained as information for detecting a motion change among images.

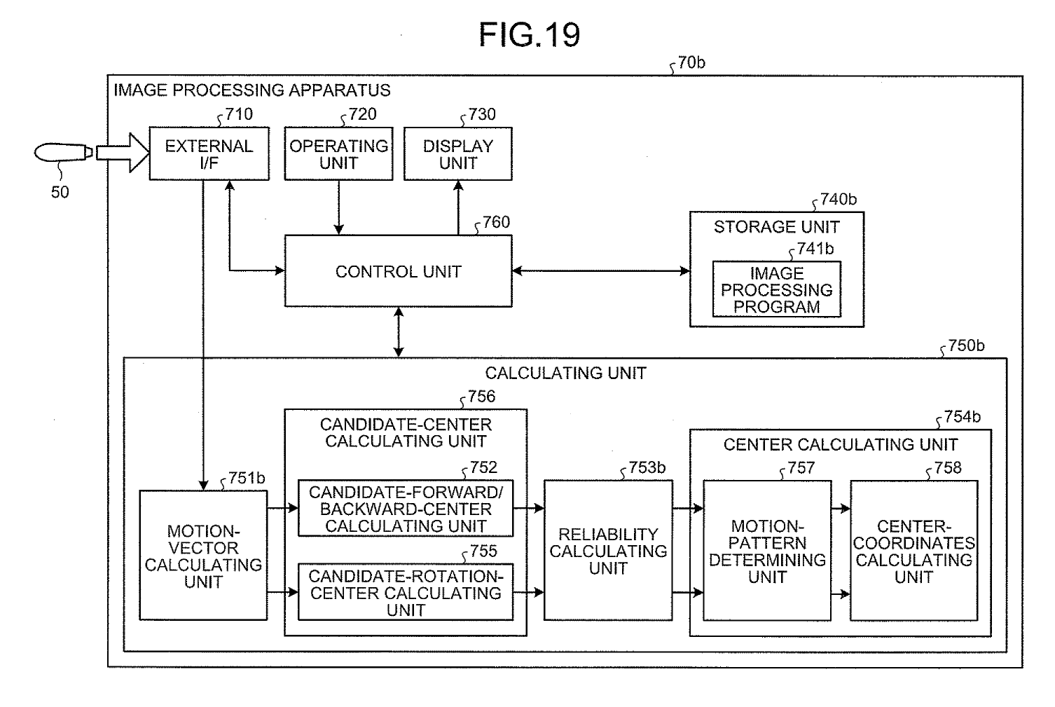

Subsequently, a third embodiment will be described below. FIG. 19 is a block diagram illustrating a functional configuration of an image processing apparatus 70b according to the third embodiment. Incidentally, portions having the same configuration as that in the first or second embodiment are denoted with the same reference numerals. In the third embodiment, the image processing apparatus 70b includes the external I/F 710, the operating unit 720, the display unit 730, a storage unit 740b, a calculating unit 750b, and the control unit 760 that controls the operation of the entire image processing apparatus 70b. The storage unit 740b stores therein an image processing program 741b for determining a motion pattern of an image taken by the capsule endoscope 10 and detecting the forward/backward center or the rotation center of an image whose motion pattern is determined as any of “the forward movement”, “the backward movement”, and “the rotational movement”.

Furthermore, the calculating unit 750b includes a motion-vector calculating unit 751b, a candidate-center calculating unit 756, a reliability calculating unit 753b, and a center calculating unit 754b. The candidate-center calculating unit 756 includes the candidate-forward/backward-center calculating unit 752 and the candidate-rotation-center calculating unit 755. The center calculating unit 754b includes a motion-pattern determining unit 757 and a center-coordinates calculating unit 758. The motion-vector calculating unit 751b calculates a motion vector in the same manner as the motion-vector calculating unit 751 in the first embodiment, and outputs a processing result to the candidate-forward/backward-center calculating unit 752 and the candidate-rotation-center calculating unit 755. The reliability calculating unit 753b calculates a reliability of the candidate forward/backward center calculated by the candidate-forward/backward-center calculating unit 752, and calculates a reliability of the candidate rotation center calculated by the candidate-rotation-center calculating unit 755. Then, the reliability calculating unit 753b outputs results of the calculation to the motion-pattern determining unit 757. The motion-pattern determining unit 757 included in the center calculating unit 754b determines a motion pattern of the image based on the reliability of the candidate forward/backward center and the reliability of the candidate rotation center calculated by the reliability calculating unit 753b. Then, when the motion pattern of the image is either “the forward movement” or “the backward movement”, the motion-pattern determining unit 757 determines that the movement of the capsule endoscope 10 or the imaging subject when the capsule endoscope 10 took the image corresponds to a forward/backward movement. On the other hand, when the motion pattern of the image is “the rotational movement”, the motion-pattern determining unit 757 determines that the movement of the capsule endoscope 10 or the imaging subject when the capsule endoscope 10 took the image corresponds to a rotational movement. The center-coordinates calculating unit 758 calculates coordinates of the forward/backward center of the image determined to correspond to the forward/backward movement, and calculates coordinates of the rotation center of the image determined to correspond to the rotational movement.

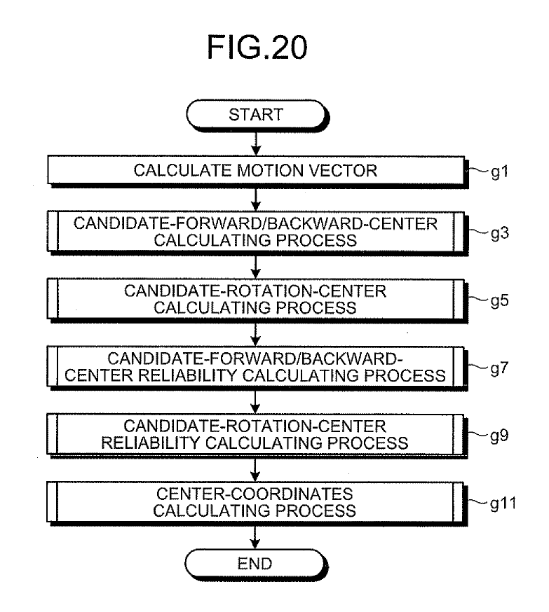

FIG. 20 is a flowchart showing a procedure of a process performed by the image processing apparatus 70b according to the third embodiment. The process explained below is carried out by the operation of each of the units in the image processing apparatus 70b in accordance with the image processing program 741b stored in the storage unit 740b. Incidentally, in the third embodiment, a motion pattern of an image taken by the capsule endoscope 10 is determined. It is determined whether the motion pattern is any of “the forward movement”, “the backward movement”, and “the rotational movement”. Images classified as motion patterns other than the above motion patterns are also objects to be processed. A motion pattern of an image can be determined by using a well-known technique arbitrarily.

As shown in FIG. 20, in the image processing apparatus 70b according to the third embodiment, first, the motion-vector calculating unit 751b calculates a motion vector (Step g1). This process is performed in the same manner as the process at Step a1 shown in FIG. 3 in the first embodiment.

Subsequently, in the candidate-center calculating unit 756, the candidate-forward/backward-center calculating unit 752 executes a candidate-forward/backward-center calculating process (Step g3), and the candidate-rotation-center calculating unit 755 executes a candidate-rotation-center calculating process (Step g5). The candidate-forward/backward-center calculating process is performed in the same manner as the process at Step a3 shown in FIG. 3 in the first embodiment. The candidate-rotation-center calculating process is performed in the same manner as the process at Step d3 shown in FIG. 12 in the second embodiment.

Subsequently, the reliability calculating unit 753b executes a candidate-forward/backward-center reliability calculating process (Step g7) and also executes a candidate-rotation-center reliability calculating process (Step g9). The candidate-forward/backward-center reliability calculating process is performed in the same manner as the process at Step a5 shown in FIG. 3 in the first embodiment. The candidate-rotation-center reliability calculating process is performed in the same manner as the process at Step d5 shown in FIG. 12 in the second embodiment.

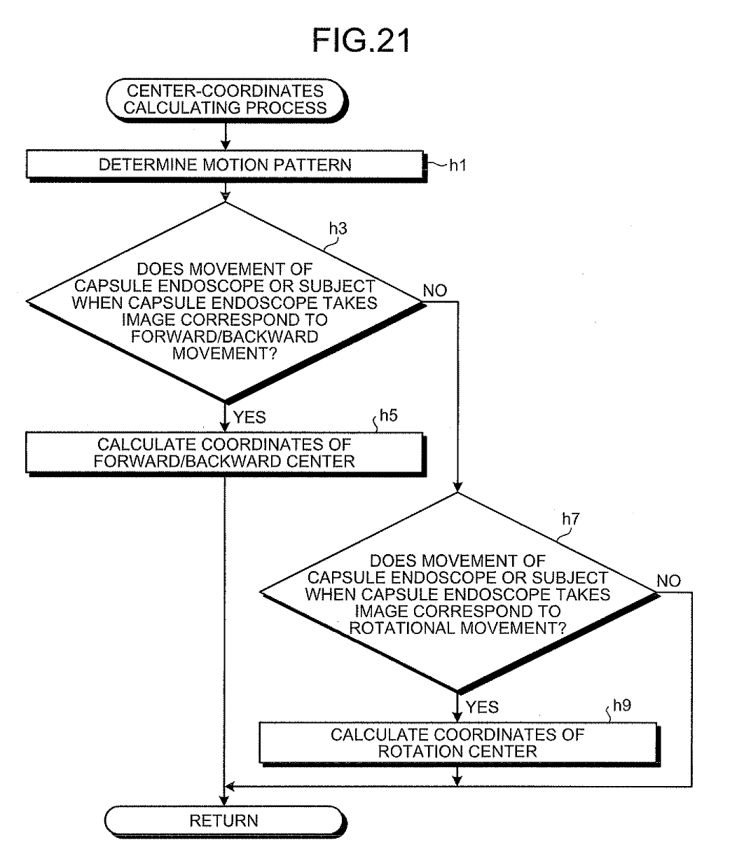

Then, the center calculating unit 754b performs a center-coordinates calculating process (Step g11). FIG. 21 shows a flowchart of a detailed processing procedure of the center-coordinates calculating process. In the center-coordinates calculating process, first, the motion-pattern determining unit 757 determines a motion pattern of an image to be processed (Step h1). Whether the motion pattern is any of “the forward movement”, “the backward movement”, and “the rotational movement” is determined based on the reliability of each of the candidate forward/backward centers calculated in the candidate-forward/backward-center reliability calculating process at Step g7 shown in FIG. 20 and the reliability of each of the candidate rotation centers calculated in the candidate-rotation-center reliability calculating process at Step g9 shown in FIG. 20. For example, the number of candidate forward/backward centers having the reliability exceeding a predetermined reference value and the number of candidate rotation centers having the reliability exceeding the predetermined reference value are determined. If the determined number is equal to or larger than a predetermined value, the motion pattern is any of “the forward movement”, “the backward movement”, and “the rotational movement”, and it is determined that the movement of the capsule endoscope 10 or the imaging subject when the capsule endoscope 10 takes the image corresponds to a forward/backward movement or a rotational movement.

Incidentally, a method for the determination is not limited to the above. It can be determined that the movement of the capsule endoscope 10 or the imaging subject when the capsule endoscope 10 takes the image corresponds to a forward/backward movement or a rotational movement, for example, if candidate forward/backward centers and candidate rotation centers exceeding a predetermined reference number are set to be concentrated in a predetermined area. Furthermore, whether the motion pattern is the forward/backward movement or the rotational movement is determined in such a manner that the reliability of each of the candidate forward/backward centers calculated in the candidate-forward/backward-center reliability calculating process at Step g7 shown in FIG. 20 and the reliability of each of the candidate rotation centers calculated in the candidate-rotation-center reliability calculating process at Step g9 shown in FIG. 20 are determined, and any of the motion patterns for which the number of candidate centers having a high value of the reliability is larger than the other is selected. When the number of candidate forward/backward centers having a high value of the reliability is larger than the number of candidate rotation centers having a high value of the reliability, the motion pattern is either “the forward movement” or “the backward movement”, and determined to correspond to the forward/backward movement. When the number of candidate rotation centers having a high value of the reliability is larger than the number of candidate forward/backward centers having a high value of the reliability, the motion pattern is “the rotational movement”, and determined to correspond to the rotational movement.

Then, as a result of the determination of the motion pattern of the image by the motion-pattern determining unit 757, when it is determined that the movement of the capsule endoscope 10 or the imaging subject when the capsule endoscope 10 took the image corresponds to the forward/backward movement (YES at Step h3), the control proceeds to Step h5. At Step h5, the center-coordinates calculating unit 758 calculates coordinates of the forward/backward center based on a coordinate value and a reliability of each of the candidate forward/backward centers. This process is performed in the same manner as the process at Step a7 shown in FIG. 3 in the first embodiment. Then, the control returns to Step g11 shown in FIG. 20. On the other hand, as a result of the determination of the motion pattern of the image, when it is determined that the movement of the capsule endoscope 10 or the imaging subject when the capsule endoscope 10 took the image does not correspond to the forward/backward movement (NO at Step h3), and when it is determined that the movement of the capsule endoscope 10 or the imaging subject corresponds to the rotational movement (YES at Step h7), the control proceeds to Step h9. At Step h9, the center-coordinates calculating unit 758 calculates coordinates of the rotation center based on a reliability of each of the candidate rotation centers. This process is performed in the same manner as the process at Step d7 shown in FIG. 12 in the second embodiment. Then, the control returns to Step g11 shown in FIG. 20. Furthermore, as a result of the determination of the motion pattern of the image, when it is determined that the movement of the capsule endoscope 10 or the imaging subject when the capsule endoscope 10 took the image does not correspond to the forward/backward movement (NO at Step h3), and does not correspond to the rotational movement (NO at Step h7), the control returns to Step g11 shown in FIG. 20.

As described above, according to the third embodiment, it is possible to achieve the same effect as in the first and second embodiments. Furthermore, it is possible to determine whether a movement of the capsule endoscope 10 or the imaging subject when the capsule endoscope 10 took an image corresponds to a forward/backward movement or a rotational movement based on calculated candidate forward/backward centers and their reliability and calculated candidate rotation centers and their reliability. Then, a result of the determination can be obtained as information for detecting a motion change among images.

Incidentally, in the above first to third embodiments, based on the forward/backward center or the rotation center, and a result of the determination whether the movement of the capsule endoscope 10 or the imaging subject when the capsule endoscope 10 took the image corresponds to the forward/backward movement or the rotational movement, which are obtained as information for detecting a motion change among images, motion patterns can be classified accurately and more finely. Therefore, with the result of the determination, it is possible to detect a motion change among images accurately. Consequently, when each image is displayed on, for example, a diagnostic workstation or the like to be checked by a doctor or the like, whether a change among images is major or not can be determined accurately, and thus it is possible to adjust a display time of each of the images appropriately. Furthermore, when images classified as “the forward movement” or “the backward movement” are continued, or when images classified as “the rotational movement” are continued, it is possible to display the center of the movement at the same position on the screen in a stabilized manner. Therefore, it is possible to improve the efficiency in checking of the images by the doctor or the like, and thus a burden of an observation can be reduced.

Moreover, if an affected area is detected during an observation of an image, a medical treatment, such as removal of tissue of the affected area, arrest of bleeding of the affected area, or removal of the affected area, is performed. To perform such a medical treatment efficiently, information on which part of the lumen where the detected affected area is located is required. At this time, by using the forward/backward center or the rotation center and a result of the determination whether the movement of the capsule endoscope 10 or the imaging subject when the capsule endoscope 10 took the image corresponds to the forward/backward movement or the rotational movement obtained in the first to third embodiments, motion patterns can be classified accurately and more finely. Therefore, based on motions among images, a travel distance of the capsule endoscope in the subject from a time point when taking an image till a time point when taking another image can be calculated accurately. Thus, it is possible to estimate the movement of the capsule endoscope in the subject accurately. Consequently, it is possible to properly grasp a position of the capsule endoscope when the capsule endoscope took each image, and also possible to estimate a position of an affected area accurately.

Furthermore, in the above embodiments, there is described a case of processing images serially-taken by the capsule endoscope as an example of an imaging device while the capsule endoscope moves through the intralumen. However, an image that the image processing apparatus according to the present invention can process is not limited to the images of the intralumen that are taken and obtained by the capsule endoscope. Namely, the image processing apparatus according to the present invention can process images serially-taken by an imaging device while the imaging device moves with respect to the subject and images serially-taken by the imaging device while the subject moves with respect to the imaging device, and can calculate the center of a movement, such as a forward/backward movement or a rotational movement, of the imaging device with respect to the subject to be seen on the images and/or the center of a movement, such as a forward/backward movement or a rotational movement, of the subject with respect to the imaging device. Moreover, the image processing apparatus according to the present invention can determine whether a movement of the imaging device or the subject when the imaging device took each of images corresponds to the forward/backward movement or the rotational movement.

The image processing apparatus, the computer program product, and the image processing method according to the embodiments make it possible to detect a motion change among images taken by the imaging device with accuracy regardless of whether the images are the ones serially taken by the imaging device while moving with respect to the subject or the ones that the imaging device serially takes the subject while moving with respect to the imaging device.

Further effect and modifications can be readily derived by persons skilled in the art. Therefore, a more extensive mode of the present invention is not limited by the specific details and the representative embodiment. Accordingly, various changes are possible without departing from the spirit or the scope of the general concept of the present invention defined by the attached claims and the equivalent.

What is claimed is:

1. An image processing apparatus comprising:
a motion-vector calculating unit that calculates motion vectors of serial images of a subject, the images being taken by an imaging device moving with respect to the subject and/or images being images of the subject moving with respect to the imaging device and taken by the imaging device;
a candidate-center calculating unit that calculates candidate centers of a movement of the imaging device and/or candidate centers of a movement of the subject seen on the images based on the motion vectors calculated by the motion-vector calculating unit;
a reliability calculating unit that calculates a reliability of each of the candidate centers based on a distance between the candidate centers calculated by the candidate-center calculating unit; and
a motion-information obtaining unit that obtains information for detecting a motion change among the images taken by the imaging device based on the reliability calculated by the reliability calculating unit.

2. The image processing apparatus according to claim 1, wherein the reliability calculating unit selects a plurality of adjacent candidate centers adjacent to the candidate center, and calculates the reliability of the candidate center based on distances between the candidate center and each of the adjacent candidate centers selected for the candidate center.

3. The image processing apparatus according to claim 1, wherein
the candidate-center calculating unit includes a candidate-forward/backward-center calculating unit that calculates candidate centers of a forward/backward movement of the imaging device and/or candidate centers of a forward/backward movement of the subject seen on the images,
the reliability calculating unit calculates the reliability of each of the candidate centers of the forward/backward movement calculated by the candidate-forward/backward-center calculating unit, and
the motion-information obtaining unit calculates a center of the forward/backward movement based on the reliability of each of the candidate centers of the forward/backward movement calculated by the reliability calculating unit, and obtains a result thus calculated as the information for detecting a motion change among the images.

4. The image processing apparatus according to claim 3, wherein the candidate-forward/backward-center calculating unit calculates intersections of straight lines passing through origins of the motion vectors calculated by the motion-vector calculating unit and being parallel to the motion vectors as the candidate centers of the forward/backward movement.

5. The image processing apparatus according to claim 4, wherein the reliability calculating unit selects adjacent candidate centers from other candidate centers of the forward/backward movement set on each of straight lines passing through the candidate center of the forward/backward movement, each adjacent candidate center being closest to the candidate center of the forward/backward movement, and the reliability calculating unit calculates the reliability of the candidate center of the forward/backward movement based on distances between the candidate center of the forward/backward movement and each of the adjacent candidate centers selected for the candidate center of the forward/backward movement.

6. The image processing apparatus according to claim 1, wherein
the candidate-center calculating unit includes a candidate-rotation-center calculating unit that calculates candidate centers of a rotational movement of the imaging device and/or candidate centers of a rotational movement of the subject seen on the images,
the reliability calculating unit calculates the reliability of each of the candidate centers of the rotational movement calculated by the candidate-rotation-center calculating unit, and
the motion-information obtaining unit calculates a center of the rotational movement based on the reliability of each of the candidate centers of the rotational movement calculated by the reliability calculating unit, and obtains a result of calculation as the information for detecting a motion change among the images.

7. The image processing apparatus according to claim 6, wherein the candidate-rotation-center calculating unit calculates intersections of straight lines passing through origins of the motion vectors calculated by the motion-vector calculating unit and being perpendicular to the motion vectors as the candidate centers of the rotational movement.

8. The image processing apparatus according to claim 7, wherein the reliability calculating unit selects adjacent candidate centers from other candidate centers of the rotational movement set on each of straight lines passing through the candidate center of the rotational movement, each adjacent candidate center being closest to the candidate center of the rotational movement, and the reliability calculating unit calculates the reliability of the candidate center of the rotational movement based on distances between the candidate center of the rotational movement and each of the adjacent candidate centers selected for the candidate center of the rotational movement.

9. The image processing apparatus according to claim 1, wherein
the candidate-center calculating unit includes
a candidate-forward/backward-center calculating unit that calculates candidate centers of a forward/backward movement of the imaging device and/or candidate centers of a forward/backward movement of the subject seen on the images; and
a candidate-rotation-center calculating unit that calculates candidate centers of a rotational movement of the imaging device and/or candidate centers of a rotational movement of the subject seen on the images,
the reliability calculating unit calculates a reliability of each of the candidate centers of the forward/backward movement calculated by the candidate-forward/backward-center calculating unit, and also calculates a reliability of each of the candidate centers of the rotational movement calculated by the candidate-rotation-center calculating unit, and
the motion-information obtaining unit determines whether the movement of the imaging device with respect to the subject and/or the movement of the subject with respect to the imaging device corresponds to the forward/backward movement or the rotational movement based on the reliability of each of the candidate centers of the forward/backward movement and the reliability of each of the candidate centers of the rotational movement calculated by the reliability calculating unit, and obtains a result of determination as the information for detecting a motion change among the images.

10. The image processing apparatus according to claim 9, wherein
the motion-information obtaining unit calculates a center of the forward/backward movement when determining that the movement of the imaging device and/or the subject corresponds to the forward/backward movement, and calculates a center of the rotational movement when determining that the movement of the imaging device and/or the subject corresponds to the rotational movement, and then obtains a result of calculation as the information for detecting a motion change among the images.

11. A computer program product having a computer readable medium including programmed instructions for processing serially-taken images of a subject taken by an imaging device moving with respect to the subject and/or serially-taken images of the subject moving with respect to the imaging device and taken by the imaging device, wherein the instructions, when executed by a computer, cause the computer to perform:
calculating motion vectors of the images taken by the imaging device;
calculating candidate centers of a movement of the imaging device and/or candidate centers of a movement of the subject seen on the images based on the calculated motion vectors;
calculating a reliability of each of the candidate centers based on a distance between the calculated candidate centers; and
obtaining information for detecting a motion change among the images taken by the imaging device based on the calculated reliability.

12. An image processing method for processing serially-taken images of a subject taken by an imaging device moving with respect to the subject and/or serially-taken images of the subject moving with respect to the imaging device and taken by the imaging device, the method comprising:
calculating motion vectors of the images taken by the imaging device;
calculating candidate centers of a movement of the imaging device and/or candidate centers of a movement of the subject seen on the images based on the calculated motion vectors;
calculating a reliability of each of the candidate centers based on a distance between the calculated candidate centers; and
obtaining information for detecting a motion change among the images taken by the imaging device based on the calculated reliability.
